(19) United States
(12) Patent Application Publication
(10) Pub. No.: US 2003/0153656 A1
(43) Pub. Date: Aug. 14, 2003

(54) FLAME RETARDANT POLYURETHANES AND POLYISOCYANURATES, AND ADDITIVES THEREFOR

(76) Inventor: Rinus Sjerps, Blanden (BE)

Correspondence Address: Mr. Philip M. Pippenger, Law Department, Albemarle Corporation, 451 Florida Street, Baton Rouge, LA, 70801-1765, US

(21) Appl. No.: 10/044,775

(22) Filed: Jan. 11, 2002

(51) Int. Cl. C08K 5/02; C09K 21/00; C08K 5/49

(52) U.S. Cl. 524/115; 252/609; 524/465

(57) ABSTRACT

A free-flowing, stable liquid flame retardant mixture comprised of or formed by mixing together components comprised of: A) tetrabromobisphenol-A; B) at least one liquid ester of a pentavalent acid of phosphorus; and C) at least one additional organic halogen-containing reactive flame retardant where the halogen is chlorine or bromine or both. Such mixtures can be effectively used in the preparation of flame-retardant polyurethanes including rigid polyurethane foams. It is preferable to include one or more liquid esters of a pentavalent acid of phosphorus in the liquid flame retardant mixture. C) is preferably at least one diester/diol of tetrabromophthalic anhydride, especially a mixed ester of tetrabromophthalic anhydride with diethylene glycol and propylene glycol, which by itself is a relatively viscous substance.

### TECHNICAL FIELD

This invention relates to flame retardant rigid polyurethane foams and rigid polyisocyanurate foams, and to novel halogen-containing flame retardant additive compositions which can be used in forming such foams.

### BACKGROUND

Rigid polyurethane foam are processed using a cast process or spray process. The cast process is generally utilized for block foam production, continuous double band lamination (DBL), and discontinuous panel production (DCP).

Block foam is produced by known discontinuous production or continuous rigid slab-stock production methods. If necessary for specialty products, the block foam is cut after production to the required shape, and is typically glued to facings to make the finished specially product. Such products find use in the building industry, in truck insulation, and in the form of half shells for pipe insulation.

Double band lamination is a continuous panel production process with both sides laminated with all kind of flexible or rigid facing materials. The polyurethane foam core is sandwiched between those facings and applied as insulation for floors, walls and roofs. Sandwich panels with a rigid metal facing are structural building elements and can be applied as roof and wall construction elements such as cold-store panels, garage doors, refrigerated trucks, and for similar uses. Sandwich panels with non-metal rigid facing, e.g., gypsum board or wood, are used in the manufacture of prefabricated houses or other building structures.

Anyone unfamiliar with the art of forming polyurethanes, polyisocyanurates, or related polymers desiring any further details already known by those of ordinary skill in the art of producing polyurethane foams, polyisocyanurate foams, or polyurethane-modified polyisocyanurate foams may refer for example to U.S. Pat. Nos. 3,954,684; 4,209,609; 5,356,943; 5,563,180; and 6,121,338, and the references cited therein.

There has been a transition in the type of blowing agents over the last decade from CFC's to HCFC's according to the Montreal Protocol because of the ozone depletion potential (ODP) of CFC'S. For countries in which the use of CFC's was abolished, this conversion typically involved switching from CFC-11 to HCFC 141b. However, the industry must soon convert from HCFC's to a third generation blowing agent with non-ODP and low global-warming potential (GWP). Alternative blowing agents are HFC's and hydrocarbons.

In practice, systemhouses prepare ready-to-use blends of all ingredients but the isocyanate(s). Typical ingredients involved are polyols, chain extenders and/or crosslinkers, water as co-blowing agent, flame retardants, catalysts and surfactants.

Fire resistance is an important property of construction materials. Bromine, chlorine and phosphorus compounds or mixtures thereof have been used effectively to comply with applicable fire safety standards. However, in addition to high effectiveness as flame retardants, it is desired to provide liquid flame retardant compositions having low viscosity that can be easily incorporated in the various types of processes used in manufacturing of rigid polyurethane foams. In addition, such compositions need to have good shelf stability, and in order to be accepted in the marketplace such compositions need to be highly cost-effective to the user.

One objective of this invention is thus to provide economical, highly effective, liquid flame retardant compositions that have good shelf stability and that can be easily blended with the other ingredients to obtain a system useful for producing flame retardant rigid polyurethane foam and rigid polyisocyanurate foam. Another objective is to provide useful and economical flame retardant rigid polyurethane foam and rigid polyisocyanurate foam made using such flame retardant compositions.

### BRIEF SUMMARY OF THE INVENTION

The foregoing objectives can be successfully accomplished by providing in one embodiment of this invention a free-flowing non-viscous liquid flame retardant additive composition comprised of or formed by mixing together components comprised of:

A) tetrabromobisphenol-A (TBBPA);

B) at least one liquid ester of a pentavalent acid of phosphorus, such as an organic phosphate and/or an organic phosphonate ester, which preferably is an alkyl phosphate ester, a chloroalkyl phosphate ester or an alkyl alkane phosphonate ester, or mixture of any two or more of these; and

C) at least one additional organic halogen-containing reactive flame retardant where the halogen is chlorine or bromine or both, preferably an organic bromine-containing reactive flame retardant.

Typically the components are proportioned such that the composition has a Brookfield viscosity at 25° C. of about 5000 centipoises (cP) or less, and preferably about 4000 centipoises (cP) or less.

As is well known in the art, a reactive flame retardant is one in which the compound contains at least one functional group, and usually more than one functional group, which is available to react with, and capable of reacting with, other polymer-forming components during polymerization so that the resultant polymer contains the flame retardant in chemically bound form in the polymer being formed. Terminal hydroxyl groups serve as one example of such reactive functional groups.

One preferred embodiment of this invention is a free-flowing non-viscous liquid flame retardant additive composition comprised of or formed by mixing together components comprised of:

A) about 15 to about 55 wt %, more preferably about 20-40 wt %, of tetrabromobisphenol-A;

B) about 15 to about 75 wt %, more preferably about 20-70 wt %, of at least one liquid alkyl or chloroalkyl phosphate ester or alkylalkane phosphonate ester, or mixture of any two or more of these;

C) about 5 to about 45 wt %, more preferably about 10-40 wt %, of a mixed ester of tetrabromophthalic anhydride with diethylene glycol and propylene glycol; and

D) optionally at least one phenolic antioxidant wherein the percentages of A), B) and C) are based on the total weight of only components A), B) and C), i.e., the weight of any optional component(s) such as a phenolic antioxidant is excluded from the calculation. Thus the total weight of components A) and B) is about 55-95 wt %, and more preferably about 60-90 wt %, depending upon the wt % of component C) used. Such compositions are typically proportioned such that the additive composition has a Brookfield viscosity at 25° C. of about 5000 centipoises (cP) or less, and preferably about 2000 centipoises (cP) or less.

An example of one subgroup of additive compositions of this invention is a free-flowing non-viscous liquid flame retardant composition comprised of or formed by mixing together components comprised of:

A) about 35 to about 40 wt % of tetrabromobisphenol-A;

B) about 50 wt % of a tris(2-chloropropyl)phosphate;

C) about 10 to about 15 wt % of a mixed ester of tetrabromophthalic anhydride with diethylene glycol and propylene glycol; and

D) optionally up to about 2000 ppm (wt/wt) of at least one phenolic antioxidant, with the total wt % of A), B), and C) being 100 wt %.

One more specific example of an additive composition of this invention is a free-flowing non-viscous liquid flame retardant composition comprised of or formed by mixing together components comprised of:

A) about 50 wt % of tetrabromobisphenol-A;

B) about 20 wt % of a tris(2-chloropropyl)phosphate;

C) about 20 wt % of diethylethanephosphonate;

D) about 10 wt % of a mixed ester of tetrabromophthalic anhydride with diethylene glycol and propylene glycol; and

E) optionally up to about 2000 ppm (wt/wt) of at least one phenolic antioxidant.

Another more specific example of one of the additive compositions of this invention is a free-flowing non-viscous liquid flame retardant composition comprised of or formed by mixing together components comprised of:

A) about 35 wt % of tetrabromobisphenol-A;

B) about 35 wt % of a tris(2-chloropropyl)phosphate;

C) about 5 wt % of triethylphosphate;

D) about 25 wt % of a mixed ester of tetrabromophthalic anhydride with diethylene glycol and propylene glycol; and

E) optionally up to about 2000 ppm (wt/wt) of at least one phenolic antioxidant.

Another embodiment of this invention is a flame-retardant composition which comprises a polyurethane, a polyisocyanurate, a rigid polyurethane foam, or a rigid polyisocyanurate foam, formed from:

a) at least one organic polyisocyanate;

b) at least one isocyanate-reactive compound;

c) a flame retardant amount of a free-flowing non-viscous liquid flame retardant composition of this invention as described herein.

Still another embodiment of this invention is the preparation of rigid polyurethane foams and rigid polyisocyanurate foams by a process which comprises reacting at least one organic polyisocyanate with a isocyanate-reactive compound in the presence of a blowing agent and a flame retardant amount of a free-flowing non-viscous liquid flame retardant composition of this invention such as those described herein.

Further embodiments of this invention are will be still further apparent from the ensuing description and appended claims.

### FURTHER DETAILED DESCRIPTION OF THE INVENTION

For preparing the polyurethanes and polyisocyanurates, including the rigid foams, of this invention, individual or mixtures of polyols with hydroxyl values in the range of from 150 to 850 mg KOH/g, and preferably in the range of from 200 to 600 mg KOH/g, and hydroxyl functionalities in the range of from 2 to 8 and preferably in the range of from 3 to 8 are used. Suitable polyols meeting these criteria have been fully described in the literature, and include reaction products of (a) alkylene oxide such as propylene oxide and/or ethylene oxide, with (b) initiators having in the range of from 2 to 8 active hydrogen atoms per molecule. Suitable initiators include, for example, diols (e.g., diethylene glycol, bisphenol-A), polyesters (e.g., polyethylene terephthalate), triols (e.g., glycerine), novolac resins, ethylenediamine, pentaerythritol, sorbitol, and sucrose. Other usable polyols include polyesters prepared by the condensation reaction of appropriate proportions of glycols and higher functionality polyols with dicarboxylic or polycarboxylic acids. The polyether polyols can be mixed with polyester types. Other polyols include hydroxyl-terminated polythioethers, polyamides, polyesteramides, polycarbonates, polyacetals and polysiloxanes.

Usable organic polyisocyanates for use in the practice of this invention include any of those known in the art for the preparation of rigid polyurethane, and in particular the aromatic polyisocyanates such as diphenylmethane diisocyanate in the form of its 2,4′-, 2,2′- and 4,4′-isomers and mixtures thereof, the mixtures of diphenylmethane diisocyanates (MDI) and oligomers thereof known in the art as “crude” or polymeric MDI (polymethylene polyphenylene polyisocyanates) having an isocyanate functionality of greater than 2, toluene diisocyanate in the form of its 2,4- and 2,6-isomers and mixtures thereof, 1,5-naphthalene diisocyanate and 1,4-diisocyanatobenzene. Other organic polyisocyanates which may be used include the aliphatic diisocyanates such as isophorone diisocyanate, 1,6-diisocyanatohexane and 4,4′-diisocyanatodicyclohexylmethane.

Trisubstituted isocyanurates are obtained by well known cyclotrimerization reactions of alkyl and aryl isocyanates, PMDI typically being used for rigid foam applications. Trimerization catalysts are bases, such as lithium oxide, sodium and potassium alkoxides, sodium formate, sodium carbonate, potassium and calcium acetates, and many others. Tertiary amines are also known to cause trimerization, and quaternary phosphonium salts are known to be effective catalysts for trimerization of aryl isocyanates. In general, alkali metal alkoxides are the most effective trimerization catalysts. For further details one may refer to Ulrich, Chemistry and Technology of Isocyanates, John Wiley and Sons, Ltd., 1996.

To manufacture the foams, the organic and/or modified organic polyisocyanates are reacted with compounds with isocyanate reactive hydrogen atoms and optionally chain extenders or cross linkers in amounts such that the equivalent ratio of isocyanate groups versus the sum of the reactive hydrogen atoms of the components ranges from 0.85 to 30:1 and preferably in the range of 0.95 to 4:1.

Polyarethanes and rigid polyurethane and polyisocyanurate foams can be prepared with or without chain extenders or cross-linkers. The mechanical properties can be modified by using these chemicals in the preparation of the polyurethanes and rigid foams of this invention. Usable chain extenders and/or cross-linkers are diols and/or triols with molecular weights lower than 250 and particularly between 50 and 200. Usable diols are aliphatic, cycloaliphatic or aromatic types, e.g., ethylene glycol, diethylene glycol, dipropylene glycol, and 1,4 butanediol. Usable triols include, for example, trimethylolpropane and glycerine.

When chain extenders and/or cross linkers are used to prepare the foams, normally they are applied in a loading of 0 to 20 weight percent and preferably from 2 to 10 weight percent relative to the weight of the polyols.

Chemicals which have been widely used as blowing agent in the production of polyurethane foam are the fully halogenated chlorofluorocarbons, and in particular trichlorofluoromethane (CFC-11). The exceptionally low thermal conductivity of these blowing agents, and in particular of CFC-11, has enabled the preparation of rigid foams having very effective insulation properties. Recent concern over the potential of chlorofluorocarbons to cause depletion of ozone in the atmosphere has led to an urgent need to develop reaction systems in which chlorofluorocarbon blowing agents are replaced by alternative materials which are environmentally acceptable and which also produce foams having the necessary properties for the many applications in which they are used. Initially, the most promising alternatives appeared to be hydrogen-containing chlorofluorocarbons (HCFC's) such as, e.g., 1,1-dichloro-1-fluoroethane (HCFC-141b). However, HCFC's also have some ozone-depletion potential. There is therefore mounting pressure to find substitutes for the HCFC's as well as the CFC's.

Alternative blowing agents which are currently considered promising because they contain no ozone-depleting chlorine are partially fluorinated hydrocarbons (HFC's) and hydrocarbons (HC's), and these blowing agents can also be used in the practice of this invention. Water can also be used as a single blowing agent or as a co-blowing agent in combination HCFC-, HFC- or HC blowing agents. Water will react with the isocyanate groups and form urea structures and release carbon dioxide.

To produce the polyurethane foam, a foam-producing amount of the blowing agent(s) is included in the reaction mixture before the polymer has been formed. Those foams have a density in the range from 20 kg/m³ to 100 kg/m³ and preferably from 25 kg/m³ to 80 kg/m³ and more preferably from 30 kg/m³ to 45 kg/m³. The amount of blowing agent will mainly determine the density of those foams. The amount will typically fall in the range of 1 to 10 percent by weight based on the total weight of the reaction mixture being foamed.

One essential brominated flame retardant component in the additive compositions and rigid polyurethane foams of this invention is tetrabromobisphenol-A (TBBPA). In combination with this brominated flame retardant, at least one other brominated flame retardant is used. For example, TBBPA is used in combination with one or more bromine-containing reactive flame retardants such as a bromine-containing diester/diol of tetrabromophthalic anhydride, dibromobutenediol and/or derivatives thereof, dibromoneopentyl glycol and/or derivatives thereof, tribromoneopentyl alcohol and/or derivatives thereof, and derivatives of TBBPA itself. Other bromine-containing flame retardants that can be used with TBBPA in the practice of this invention are tribromophenol and/or derivatives thereof, octabromobiphenyl, decabromobiphenyl, octabromobiphenylether, decabromobiphenylether, pentabromobenzene, tris(2-bromoethyl)phosphate, and similar substances. In combination with the brominated flame retardants, at least one non-brominated flame retardant is used, such as for example tris(2-chloroethyl)phosphate, trimethylphosphate, triethylphosphate, tris(2-chloroisopropyl)phosphate, dimethylmethanephosphonate, diethylethanephosphonate, tris(dichloropropyl)phosphate, chlorinated paraffin, and similar organic phosphorus and/or organic chlorine flame retardants. Apart from these phosphorus and or chlorine-containing flame retardants, other organic or inorganic flame retardants such as red phosphorus, ammonium polyphosphate, and melamine can be used in combination with the TBBPA and other flame retardant components used therewith.

Preferred non-brominated flame retardants for use in the practice of this invention are one or more tris(chloropropyl)phosphates in which the propyl groups are n-propyl, isopropyl, or both. In other words it is preferred to employ a tris(2-chloropropyl)phosphate, i.e., tris(2-chloro-n-propyl)phosphate, tris(2-chloroisopropyl)phosphate, di(2-chloro-n-propyl)(chloroisopropyl phosphate, di(2-chloroisopropyl)(2-chloro-n-propyl)phosphate, or a mixture of any two or any three or all four of these compounds. Also preferred as a non-brominated flame retardant component for use in the practice of this invention is diethylethanephosphonate, (EtO₂)(Et)P═O, a.k.a. diethylethylphosphonate, or a combination of diethylethanephosphonate with a tris(2-chloropropyl)phosphate as just described. Another preferred non-brominated flame retardant component for use in the practice of this invention is triethylphosphate, especially when used in combination with a tris(2-chloropropyl)phosphate.

A feature of this invention is the provision in preferred embodiments of a free-flowing liquid flame retardant with excellent cost-effectiveness. Despite the fact that tetrabromobisphenol-A is a solid at ordinary room temperatures, and despite the fact that a number of the preferred non-brominated flame retardants such as a tris(chloropropyl)phosphate are known to be effective plasticizer for polymers, the combinations of these components with a viscous component such as a diester/diol of tetrabromophthalic anhydride pursuant to this invention results in a flame retardant composition which not only is a free-flowing liquid with excellent flame retardant effectiveness, but which can produce polyurethanes or polyisocyanurates meeting the physical requirements for rigid foam applications.

The liquid flame retardant additive compositions of this invention composed of (i) tetrabromobisphenol-A, (ii) at least one liquid ester of a pentavalent acid of phosphorus, such as a liquid trialkylphosphate, a liquid tri(monochloroalkyl- or dichloroalkyl)phosphate, and/or a liquid dialkylalkanephosphonate, and (iii) at least one other organic bromine-containing flame retardant, which preferably is a reactive flame retardant, will typically contain at least about 30 wt % of tetrabromobisphenol-A based on the weight of (i) and (iii). Preferably the mixture of (i), (ii), and (iii) will contain in the range of 30 to 80 wt % of (i) and (iii), with the proviso that the composition is a free-flowing liquid at room temperature. Component (i) is preferably highly pure tetrabromobisphenol-A, but which can be a less pure mixture containing small amounts of under brominated bisphenol-A molecules. SAYTEX® CP-2000 flame retardant (Albemarle Corporation) is a preferred highly pure tetrabromobisphenol-A flame retardant. If tribromophenol is used as component (iii), it can be any isomer or mixture of isomers thereof that provides, when mixed with the other components of the flame retardant additive composition, a free-flowing liquid at room temperature. Thus isomers such as 2,4,6-tribromophenol, 2,4,5-tribromophenol, 2,3,5-tribromophenol, 2,3,6-tribromophenol, etc., or mixtures of any two or more such isomers can be used.

Antioxidants and thermal stabilizers can be and preferably are used in the compositions of this invention. These are preferably compounds known in the art as phenolic antioxidants. Non-limiting examples of such materials include such compounds as 2,6-di-tert-butyl-p-cresol, 4,4′-methylenebis(2,6-di-tert-butylphenol), 2,2′-methylenebis(4,6-di-tert-butylphenol), octadecyl 3,5-di-tert-butyl-4-hydroxyhydrocinnamate, 1,3,5-trimethyl-2,4,6-tris(3,5-di-tert-butyl-4-hydroxybenzyl)benzene, tris(3,5-di-tert-butyl-4-hydroxybenzyl)isocyanurate, crystalline tetrakis[3-(3,5-di-tert-butyl-4-hydroxyphenyl)propionyloxymethyl]-methane, n-octadecyl-3-(3′,5′-di-tert-butyl-4-hydroxyphenyl)propionate, 2,2-bis[3′,5′-di-tert-butyl-4′-hydroxyphenylpropionyloxyethoxyphenyl]propane, triethyleneglycol-bis[3-(3′-tert-butyl-4′-hydroxy-5-methylphenyl)propionate, and 1,5-bis(3′,5′-di-tert-butyl-4′-hydroxyphenyl-propionyloxy)-3′-thiopentane. Octadecyl 3,5-di-tert-butyl-4-hydroxyhydrocinnanate has been found to be especially effective for use in the compositions of this invention, and thus is a particularly preferred stabilizer.

Catalysts for rigid foam applications can be categorized as gel catalysts, blow catalysts, balanced gel/blow catalysts and trimerization catalysts. Gel catalysts promote the reaction between the reactive hydrogen atoms, particularly of the hydroxyl groups, and the modified polyisocyanates. Blow catalysts promote the reaction of the reactive hydrogen of water and the modified polyisocyanate. Trimerization catalysts promote the reaction between isocyanates and result in isocyanurates. Suitable catalysts are organic metal compounds, particularly the organic tin compounds like the stannous(II) salts of organic carboxylic acids, e.g., stannous(II) octoate and stannous(II) acetate; dialkyltin(IV) salts of carboxylic acids, e.g., dibutyltin dilaurate and dioctyltin diacetate. Other suitable catalysts are tertiary amines which can be used as a single catalyst or in combination with one or more of the tin compounds. Examples of suitable tertiary amines as blowing catalyst include e.g. bis(dimethylaminoethyl)ether and pentamethyldiethylenetriamine. Examples of gel catalysts include 1,4-diaza(2,2,2)bicyclooctane; tetramethyldipropylenetriamine; tris(dimethylamino-propyl)hydrotriazine. Examples of balanced catalysts include dimethylcyclohexylamine, pentamethyldipropylenetriamine and tris(dimethylaminopropyl)hydrotriazine. Examples of trimerization catalysts include potassium octoate and potassium acetate. The catalysts are usually used in amounts of from 0.001 to 2 parts by weight per 100 parts by weight of the polyol blend.

Surfactants can be used in the formulation if desired. They serve as a surface-active substance in order to improve the compatibility of the various components of the formulation and to control the cell structure. Examples of suitable surfactants are emulsifiers such as sodium salts of castor oil sulfates or fatty acids; fatty acid salts with amines, e.g., diethylamine oleate and diethanolamine stearate; salts of sulfonic acids, e.g., alkali metal or ammonium salts of dodecylbenzenedisulfonic acid and ricinoleic acid; foam stabilizers such as siloxaneoxyalkylene copolymers and other organopolysiloxanes, ethoxylated alkylphenols, ethoxylated fatty alcohols and castor oil. These surface active substances are usually used in amounts of from 0.01 to 5 parts by weight based on 100 parts by weight of polyol blend.

When forming the flame retarded polyurethane or polyisocyanurate polymers or rigid foams of this invention, it is possible to introduce the flame retardant components into the mixture to be polymerized individually and/or as one or more preformed mixtures. However, it is definitely preferably to add the components in the form of a preformed free-flowing flame retardant additive composition of this invention to the mixture to be polymerized, as this ensures more uniform distribution of the components within such polymerization mixture. In addition, the use of a preformed free-flowing flame retardant additive composition of this invention simplifies the blending operation at the polymerization site, and minimizes the possibility of blending errors.

The polyurethanes, polyisocyanurates, rigid polyurethane foams, and rigid polyisocyanurate foams of this invention contain a flame retardant amount of the additives of this invention. Typically, the additive compositions of this invention are used in amounts providing a total bromine concentration in the polymer in the range of about 1 to about 20 wt % based on the total weight of the polymer and the additives of this invention, but excluding the weight of any cladding, lamination, or coatings on the polymer or foam. Preferably such total bromine concentration is in the range of about 4 to about 15 wt % and more preferably is in the range of about 6 to about 10 wt % based on the total weight of the polymer and the additives of this invention, but excluding the weight of any cladding, lamination, or coatings on the polymer or foam. Most preferably the amount of the flame retardants of this invention used is at least sufficient to meet the present requirements of the DIN 4102 B2 test procedure.

The following Examples further illustrate the invention. These Examples are not intended to limit, and should not be construed as limiting, the generic scope of this invention.

The materials used in the Examples included the following:

Polyol:

Polyether polyol based on sucrose having an OH number of 403 mg KOH/g, and a viscosity of 2175 mPas.s at 25° C.);

Reactive Flame Retardants:

1. Tetrabromobisphenol-A (SAYTEX® CP-2000 flame retardant; Albemarle Corporation)

2. A bromine-containing diester/diol of tetrabromophthalic anhydride (SAYTEX® RB-79 flame retardant; Albemarle Corporation)

Non-Reactive Flame Retardants:

1. Tris(2-chloroisopropyl)phosphate (FYROL® PCF; Akzo Nobel NV)

2. Diethylethanephosphonate (AMGARD® V490; Rhodia Chimie)

3. Triethylphosphate (Bayer A. G.)

Polymeric Isocyanate:

Universal MDI with average functionality and higher reactivity, with an NCO content of 31.2%, and a viscosity of 200 mPas.s at 25° C.)

Foam Stabilizer:

Non-hydrolyzable polysiloxane-polyethercopolymer surfactant (DABCO® DC 5522, Air Products and Chemicals, Inc.)

Catalysts:

1. Pentamethyldiethylenetriamine (POLYCAT® 5; Air Products and Chemicals, Inc.)

2. 1,4-Diaza(2,2,2)bicyclooctane (DABCO 33LV, Air Products and Chemicals, Inc.)

3. Potassium Octoate (DABCO® K15, Air Products and Chemicals, Inc.)

Examples 1, 2, 6, and 8-16 are illustrative of the stable, free-flowing additive formulations of this invention, and their preparation. Examples 3, 4, and 7 illustrate the polyurethane foams of this invention, and the preparation and properties thereof. Example 5 is a comparative example.

### EXAMPLE 1

A mixture of 15 grams of the reactive bromine-containing diester/diol of tetrabromophthalic anhydride (SAYTEX® RB-79 flame retardant) and 50 grams of tris(2-chloroisopropyl)phosphate was formed and heated up to 60° C. At this temperature a stabilizer (octadecyl 3,5-di-tert-butyl-4-hydroxyhydrocinnamate) was added and dissolved in the mixture. The stabilizer is added to extend the long term heat stability during aging. Tetrabromobisphenol-A (SAYTEX® CP-2000 flame retardant, 35 grams) was added portionwise to this mixture while increasing the temperature to 80° C. After all of the SAYTEX® CP-2000 flame retardant had been added, stirring was continued for a time period of about 2 hours. This blend was a clear, stable solution with a viscosity of around 4000 cP at 25° C.

### EXAMPLE 2

A mixture of 10 grams of the reactive bromine-containing diester/diol of tetrabromophthalic anhydride (SAYTEX® RB-79 flame retardant), 20 grams of tris(2-chloroisopropyl)phosphate and 20 grams of diethylethylphosphonate was formed and heated up to 60° C. Tetrabromobisphenol-A (SAYTEX® CP-2000 flame retardant, 50 grams) was added portionwise to this mixture while increasing the temperature to 80° C. Stirring was continued for about 2 hours after all of the SAYTEX® CP-2000 flame retardant had been added. This blend was a clear, stable solution with a viscosity of around 1500 cP at 25° C. and did not precipitate out on standing at room temperature for an examination period of at least 2 months.

### EXAMPLES 3-5

Foam samples were molded with dimensions of L300×W300×H80 mm. The procedure, used in each instance, involved first adding to a mixing vessel the above sucrose polyether polyol, followed by water, glycerine, the above catalysts, the flame retardant additives, and the above foam stabilizer. In Example 3, the flame retardant of this invention used (“Additive A”) was blend of 40 wt % of SAYTEX® CP-2000 flame retardant, 50 wt % of Fyrol PCF, 10 wt % of SAYTEX® RB-79 flame retardant and about 2000 ppm of octadecyl 3,5-di-tert-butyl-4-hydroxyhydrocinnamate plus additional tris(2-chloroisopropyl)phosphate (Fyrol PCF). In Example 4 the flame retardant used (“Additive B”) was a portion of the above Example 2 additive blend of this invention. In Example 5, no tetrabromobisphenol-A (“TBBPA”) was used. Instead, SAYTEX® RB-79 flame retardant and Fyrol PCF flame retardant were added as the flame retardant system. In each instance, the resultant polyol mixture was stirred to form a homogeneous solution. To this solution were added normal pentane and the above polymeric isocyanate (“PMDI”), and the mixture was stirred at high speed for 10 seconds and poured into an aluminum mold maintained at 35° C. The foam that formed was kept in the mold for 0.5 hour and then this “mother sample” of foam was removed from the mold and aged for two days at room temperature. The requisite test specimens were then cut from the mother sample by means of a saw for further conditioning according to the applicable test standards. After the required conditioning, the samples were subjected to testing. Table 1 summarizes the proportions of the ingredients in each of the three foams of Examples 3, 4 and 5, respectively. All units are in terms of weight.

TABLE 1

| Ingredient | Ex.3 | Ex.4 | Ex.5 |
|---|---|---|---|
| Polyol | 77.9 | 80.3 | 70.2 |
| Additive A | 81.4 | | |
| Additive B | | 74.4 | |
| SAYTEX ® RB-79 flame retardant | | | 49.6 |
| Fyrol PCF flame retardant | 2 | | 41.7 |
| Water | 2.3 | 2.3 | 2.25 |
| Glycerine | 9.8 | 9.9 | 9.77 |
| Dabco DC5522 | 1.3 | 1.2 | 1.2 |
| Polycat 5 | 0.5 | 0.3 | 0.35 |
| Dabco 33LV | 0.6 | 0.5 | 0.7 |
| Dabco K15 | 0.2 | | |
| n-Pentane | 11 | 11 | 11 |
| PMDI (Index 110) | 190 | 195 | 187 |

The conditioned samples of Examples 3-5 were tested for compression strength according to the DIN 53421 test procedure, dimensional stability according to the ASTM D2126-87 test procedure, and flammability rating according to the DIN4102 B2 test procedure. Table 2 summarizes the results of this physical property testing of the foams. In Table 2, results on compression strength are given in terms of compression strength measured parallel to the rise direction of the foam and also perpendicular to the rise direction.

TABLE 2

| Foam Property | Ex.3 | Ex.4 | Ex.5 |
|---|---|---|---|
| Density, kg/m³ | 42.1 | 42.6 | 42.1 |
| Flammability*, cm | <15 | <14 | <15 |
| Compressive strength, Parallel, kPa | >200 | >200 | >200 |
| Compressive strength, Perpendicular, kPa | >200 | >200 | >200 |
| Dimensional stability, volume % after | <2 | <2 | <3 |
| 4 weeks at 70° C. and 95% relative humidity | | | |

*DIN 4102 B2 test procedure.

It can thus be seen that polyurethane foams formed as above based on sucrose polyol, tetrabromobisphenol-A flame retardant (e.g., SAYTEX® CP-2000 flame retardant; Albemarle Corporation), a reactive bromine containing diester/diol of tetrabromophthalic anhydride (SAYTEX® RB-79 flame retardant; Albemarle Corporation) and tris(2-chloroisopropyl)phosphate (FYROL® PCF; Akzo Nobel) with and without inclusion of diethylethanephosphonate, and blown with normal pentane blowing agent, had good physical properties and met the German DIN4102 B2 fire safety standards.

### EXAMPLE 6

A mixture of 50 grams of the reactive bromine-containing diester/diol of tetrabromophthalic anhydride (SAYTEX® RB-79 Flame Retardant) and 70 grams of tris(2-chloroisopropyl)phosphate and 10 grams of triethylphosphate was formed and heated up to 60° C. At this temperature a stabilizer (octadecyl 3,5-di-tert-butyl-4-hydroxyhydrocinnamate) was added and dissolved in the mixture. The stabilizer is added to extend long term heat stability during aging. SAYTEX® CP-2000 flame retardant (70 grams) was added portionwise to this mixture while increasing the temperature to 80° C. After all of the SAYTEX® CP-2000 had been added, stirring was continued for a time period of about half an hour. This blend was a clear, stable solution with a viscosity of around 5000 cP at 25° C., and did not precipitate out on standing at room temperature for an examination period of at least one month.

### EXAMPLE 7

Using the procedure of Example 3, a polyurethane was formed using the following components: 82.2 g of polyol; 72.2 g of the additive of Example 6; 2.3 g of water; 9.9 g of glycerol; 1.2 g of DABCO® DC5522; 0.3 g of POLYCAT® 5; 0.6 g of DABCO® 33LV; 11.5 g of n-pentane; and 196 g of PMDI (Index 110). Table 3 summarizes the physical properties of the conditioned foam.

TABLE 3

| Foam Property | Ex.7 |
|---|---|
| Density, kg/m³ | 41.9 |
| Flammability*, cm | 16.3 |
| Compressive strength, Parallel, kPa | 217 |
| Compressive strength, Perpendicular, kPa | 188 |
| Dimensional stability, after 2 weeks, average of length + | −0.63 |
| width in percent | |
| Dimensional stability, after 2 weeks, average of height in percent | 2 |

*DIN 4102 B2 test procedure.

Although this foam did not pass the B2 flammability test which has a limit of 15 cm flame height, it is expected that use of a larger amount of the Example 6 additive would result in achieving the requirements of this particular flammability test.

### EXAMPLES 8-16

Nine additional flame retardant additives of this invention were prepared and evaluated for storage stability. Table 4 summarizes the makeup of these additive compositions and the results of the stability tests which are still ongoing. In Table 4 the ingredients used were TBBPA (SAYTEX® CP 2000 flame retardant), RB-79 (SAYTEX® RB-9 flame retardant), TCPP (tris(2-chloroisopropyl)phosphate), and 1076 (IRGANOX® 1076 additive). The values given for stability represent the length of time during which the additive samples have been stored under ambient room temperature conditions without precipitate formation or other visually perceptive degradation having occurred. The tests are continuing and thus the values given are not limits on stability.

TABLE 4

| | TBBPA, | RB-79, | | | Stability, |
|---|---|---|---|---|---|
| Example | wt % | wt % | TCPP, wt % | 1076, wt % | days |
| 8 | 40 | 40 | 20 | 0.2 | 29 |
| 9 | 20 | 40 | 40 | 0.1 | 52 |
| 10 | 30 | 25 | 45 | 0.15 | 50 |
| 11 | 40 | 25 | 35 | 0.2 | 29 |
| 12 | 20 | 10 | 70 | 0.1 | 52 |
| 13 | 25 | 17.5 | 57.5 | 0.125 | 50 |
| 14 | 30 | 40 | 30 | 0.15 | 50 |
| 15 | 30 | 32.5 | 37.5 | 0.15 | 50 |
| 16 | 20 | 25 | 55 | 0.1 | 50 |

The flame retardant additive compositions of this invention can be used in any of a variety of polyurethanes and polyisocyanurates (including modified polyurethane and/or polyisocyanurate polymers), and in foams thereof, especially rigid foams thereof. Non-limiting examples of polymers and rigid foams in which the flame retardant additive compositions of this invention can be used include polymers and foams described in U.S. Pat. Nos. 3,954,684; 4,209,609; 5,350,780; 5,356,943; 5,367,000; 5,563,180; 6,121,338; 6,140,383 and references cited therein dealing with such subject matter. All such patents and references are incorporated herein by reference as if fully set forth herein.

Compounds referred to by chemical name or formula anywhere in this document, whether referred to in the singular or plural, are identified as they exist prior to coming into contact with another substance referred to by chemical name or chemical type (e.g., another component, or a solvent. It matters not what preliminary chemical changes, if any, take place in the resulting mixture or solution, as such changes are the natural result of bringing the specified substances together under the conditions called for pursuant to this disclosure. Also, even though the claims may refer to substances in the present tense (e.g., “comprises” or “is”), the reference is to the substance as it exists at the time just before it is first contacted, blended or mixed with one or more other substances in accordance with the present disclosure.

All documents referred to herein are incorporated herein in toto as if fully set forth in this document.

This invention is susceptible to considerable variation within the spirit and scope of the appended claims.

That which is claimed is:

1. A free-flowing non-viscous liquid flame retardant composition comprised of or formed by mixing together components comprised of:
A) tetrabromobisphenol-A;
B) at least one liquid ester of a pentavalent acid of phosphorus; and
C) at least one additional organic halogen-containing reactive flame retardant where the halogen is chlorine or bromine or both;
in proportions such that the composition has a Brookfield viscosity at 25° C. of about 5000 centipoises (cP) or less.

2. A composition of claim 1 wherein B) is at least one tri(chloroalkyl) phosphate.

3. A composition of claim 1 wherein B) is a tris(2-chloropropyl)phosphate.

4. A composition of claim 1 wherein B) is a tris(2-chloropropyl)phosphate and a liquid dialkylalkanephosphonate.

5. A composition of claim 1 wherein B) is a tris(2-chloropropyl)phosphate and a liquid trialkylphosphate.

6. A composition of claim 1 wherein C) is at least one organic bromine-containing reactive flame retardant.

7. A composition of claim 6 wherein B) is at least one organic phosphate ester and/or at least one organic phosphonate ester.

8. A composition of claim 6 wherein B) is at least one alkyl or chloroalkyl phosphate ester and/or at least one dialkylalkane phosphonate ester.

9. A composition of claim 1 wherein C) is at least one diester/diol of tetrabromophthalic anhydride.

10. A composition of claim 1 wherein C) a mixed ester of tetrabromophthalic anhydride with diethylene glycol and propylene glycol.

11. A composition of claim 9 wherein B) is at least one organic phosphate ester and/or at least one organic phosphonate ester.

12. A composition of claim 9 wherein B) is at least one alkyl or chloroalkyl phosphate ester and/or at least one dialkylalkane phosphonate ester.

13. A composition of claim 9 wherein B) is a tris(2-chloropropylphosphate or diethylethanephosphonate, or both.

14. A composition of claim 9 wherein B) is (i) a tris(2-chloropropylphosphate, (ii) a tris(2-chloropropylphosphate and diethylethanephosphonate, or (iii) a tris(2-chloropropylphosphate and triethylphosphate.

15. A free-flowing non-viscous liquid flame retardant composition comprised of or formed by mixing together components comprised of:
A) about 15 to about 55 wt % of tetrabromobisphenol-A;
B) about 15 to about 75 wt % of at least one liquid alkyl or chloroalkyl phosphate or at least one liquid alkyl phosphonate ester, or mixture of any two or more of these;
C) about 5 to about 45 wt % of at least one diester/diol of tetrabromophthalic anhydride;
and optionally
D) at least one phenolic antioxidant;
wherein the percentages of A), B) and C) are based on the total weight of only components A), B) and C).

16. A composition of claim 15 wherein C) is a mixed ester of tetrabromophthalic anhydride with diethylene glycol and propylene glycol.

17. A composition of claim 15 wherein B) is a tris(2-chloropropylphosphate or diethylethanephosphonate, or both.

18. A composition of claim 15 wherein B) is (i) a tris(2-chloropropylphosphate, (ii) a tris(2-chloropropylphosphate and diethylethanephosphonate, or (iii) a tris(2-chloropropylphosphate and triethylphosphate.

19. A composition of claim 15 wherein said flame retardant composition comprised of or formed by mixing together components comprised of A), B), C) and D) thereof, and wherein D) is octadecyl 3,5-di-tert-butyl-4-hydroxyhydrocinnamate.

20. A free-flowing non-viscous liquid flame retardant composition comprised of or formed by mixing together components comprised of:
A) about 20 to about 40 wt % of tetrabromobisphenol-A;
B) about 20 to about 70 wt % of at least one liquid alkyl or chloroalkyl phosphate or at least one liquid alkyl phosphonate ester, or mixture of any two or more of these;
C) about 10 to about 40 wt % of at least one diester/diol of tetrabromophthalic anhydride; and optionally
D) at least one phenolic antioxidant;
wherein the percentages of A), B) and C) are based on the total weight of only components A), B) and C).

21. A composition of claim 20 wherein C) is a mixed ester of tetrabromophthalic anhydride with diethylene glycol and propylene glycol.

22. A composition of claim 20 wherein B) is a tris(2-chloropropylphosphate or diethylethanephosphonate, or both.

23. A composition of claim 20 wherein B) is (i) a tris(2-chloropropylphosphate, (ii) a tris(2-chloropropylphosphate and diethylethanephosphonate, or (iii) a tris(2-chloropropylphosphate and triethylphosphate.

24. A composition of claim 20 wherein said flame retardant composition comprised of or formed by mixing together components comprised of A), B), C) and D) thereof, and wherein D) is octadecyl 3,5-di-tert-butyl-4-hydroxyhydrocinnamate.

25. A free-flowing non-viscous liquid flame retardant composition comprised of or formed by mixing together components comprised of:
A) about 35 to about 40 wt % of tetrabromobisphenol-A;
B) about 50 wt % of a tris(2-chloropropyl)phosphate;
C) about 10 to about 15 wt % of a mixed ester of tetrabromophthalic anhydride with diethylene glycol and propylene glycol; and
D) optionally up to about 2000 ppm (wt/wt) of at least one phenolic antioxidant;
wherein the total wt % of A), B), and C) adds up to 100 wt %.

26. A composition of claim 25 wherein said composition is comprised of about 35 wt % of A), about 50 wt % of B), and about 15 wt % of C).

27. A free-flowing non-viscous liquid flame retardant composition comprised of or formed by mixing together components comprised of:
A) about 50 wt % of tetrabromobisphenol-A;
B) about 20 wt % of a tris(2-chloropropyl)phosphate;
C) about 20 wt % of diethylethanephosphonate;
D) about 10 wt % of a mixed ester of tetrabromophthalic anhydride with diethylene glycol and propylene glycol; and
E) optionally up to about 2000 ppm (wt/wt) of at least one phenolic antioxidant.

28. A free-flowing non-viscous liquid flame retardant composition comprised of or formed by mixing together components comprised of:
A) about 35 wt % of tetrabromobisphenol-A;
B) about 35 wt % of a tris(2-chloropropyl)phosphate;
C) about 5 wt % of triethylphosphate;
D) about 25 wt % of a mixed ester of tetrabromophthalic anhydride with diethylene glycol and propylene glycol; and
E) optionally up to about 2000 ppm (wt/wt) of at least one phenolic antioxidant.

29. A flame-retardant composition which comprises a polyurethane or polyisocyanurate polymer formed from components comprised of:
a) at least one organic polyisocyanate;
b) at least one isocyanate-reactive compound;
c) a flame retardant amount of a free-flowing non-viscous liquid flame retardant composition as claimed in any of claims 1-27.

30. A flame-retardant composition which comprises a polyurethane or polyisocyanurate polymer formed in the presence of flame retardant components comprised of:
1) about 15 to about 55 wt % of tetrabromobisphenol-A;
2) about 15 to about 75 wt % of at least one liquid alkyl or chloroalkyl phosphate or at least one liquid alkyl phosphonate ester, or mixture of any two or more of these;
3) about 5 to about 45 wt % of at least one diester/diol of tetrabromophthalic anhydride; and optionally
4) at least one phenolic antioxidant;
wherein the percentages of 1), 2) and 3) are based on the total weight of only components 1), 2) and 3).

31. A composition of claim 30 wherein C) is a mixed ester of tetrabromophthalic anhydride with diethylene glycol and propylene glycol.

32. A composition of claim 30 wherein said polymer is formed from components comprised of 1), 2), 3), and 4) thereof.

33. A composition of claim 32 wherein component 4) is octadecyl 3,5-di-tert-butyl-4-hydroxyhydrocinnamate.

34. A composition as claimed in any of claims 30-33 wherein B) is (i) a tris(2-chloropropylphosphate, (ii) a tris(2-chloropropylphosphate and diethylethanephosphonate, or (iii) a tris(2-chloropropylphosphate and triethylphosphate.

35. A flame-retardant composition which comprises a polyurethane or polyisocyanurate polymer formed in the presence of flame retardant components comprised of:
1) about 20 to about 40 wt % of tetrabromobisphenol-A;
2) about 20 to about 70 wt % of at least one liquid alkyl or chloroalkyl phosphate or at least one liquid alkyl phosphonate ester, or mixture of any two or more of these;
3) about 10 to about 40 wt % of at least one diester/diol of tetrabromophthalic anhydride; and optionally
4) at least one phenolic antioxidant;
wherein the percentages of 1), 2) and 3) are based on the total weight of only components 1), 2) and 3).

36. A composition of claim 35 wherein C) is a mixed ester of tetrabromophthalic anhydride with diethylene glycol and propylene glycol.

37. A composition of claim 35 wherein said polymer is formed from components comprised of 1), 2), 3), and 4) thereof.

38. A composition of claim 37 wherein component 4) is octadecyl 3,5-di-tert-butyl-4-hydroxyhydrocinnamate.

39. A composition as claimed in any of claims 35-38 wherein B) is (i) a tris(2-chloropropylphosphate, (ii) a tris(2-chloropropylphosphate and diethylethanephosphonate, or (iii) a tris(2-chloropropylphosphate and triethylphosphate.

40. A process of preparing a rigid polyurethane foam or polyisocyanurate foam, which process comprises polymerizing at least one organic polyisocyanate with at least one isocyanate-reactive compound in the presence of components comprised of or formed from components comprised of at least one polymerization catalyst, at least one blowing agent and a flame retardant amount of a free-flowing non-viscous liquid flame retardant composition as claimed in any of claims 1-28.

41. A process of preparing a rigid polyurethane foam or polyisocyanurate foam, which process comprises polymerizing at least one organic polyisocyanate with at least one isocyanate-reactive compound in the presence of components comprised of or formed from components comprised of at least one polymerization catalyst, at least one blowing agent and flame retardant components comprised of:
1) about 15 to about 55 wt % of tetrabromobisphenol-A;
2) about 15 to about 75 wt % of at least one liquid alkyl or chloroalkyl phosphate or at least one liquid alkyl phosphonate ester, or mixture of any two or more of these;
3) about 5 to about 45 wt % of at least one diester/diol of tetrabromophthalic anhydride;
wherein the percentages of 1), 2) and 3) are based on the total weight of only components 1), 2) and 3), and wherein said flame retardant components 1), 2) and 3) are added to the polymerization mixture individually and/or as one or more preformed mixtures.

42. A process of claim 41 wherein 3) is a mixed ester of tetrabromophthalic anhydride with diethylene glycol and propylene glycol.

43. A process as claimed in any of claims 41-42 wherein 2) is (i) a tris(2-chloropropylphosphate, (ii) a tris(2-chloropropylphosphate and diethylethanephosphonate, or (iii) a tris(2-chloropropylphosphate and triethylphosphate.

44. A process of claim 41 wherein about 20 to about 40 wt % of 1), about 20 to about 70 wt % of 2), and about 10 to about 40 wt % of 3) are used.
